(19) United States
(12) Patent Application Publication
(10) Pub. No.: US 2005/0084137 A1
(43) Pub. Date: Apr. 21, 2005

(54) System and method for iris identification using stereoscopic face recognition

(76) Inventors: Dae-Hoon Kim, Seoul (KR); Byung-Ho Choi, Seoul (KR); Seung-Min Paik, Seoul (KR)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/501,569

(22) PCT Filed: Jan. 15, 2003
(86) PCT No.: PCT/KR03/00086

(30) Foreign Application Priority Data
Jan. 16, 2002 (KR) 10 20020002632

(51) Int. Cl. G06K 9/00

(52) U.S. Cl. 382/115; 382/154

(57) ABSTRACT

Disclosed herein is a system and method for iris recognition including stereoscopic face recognition, which can recognize irises including stereoscopic face recognition system in order to recognize an authenticatee. The system includes two or more face recognition cameras for photographing two or more face images of an authenticatee; a recognition system for receiving the face images photographed by the face recognition cameras from the face recognition cameras and creating stereoscopic face information on the basis of the face images; and one or more iris recognition cameras controlled by the recognition system to photograph focused irises of the authenticatee using the created stereoscopic face information.

### FIELD OF THE INVENTION

The present invention relates generally to a system and method for iris recognition using stereoscopic face recognition, which can recognize irises using a stereoscopic face image in order to recognize an authenticatee.

### DESCRIPTION OF THE PRIOR ART

As well known to those skilled in the art, in biometrics technologies in which parts of a human body are considered as recognition objects to recognize a person, iris, face, fingerprint, vein and the like recognition technologies are independently utilized.

However, certain biometrics technologies cannot be applied to certain persons. For example, the iris recognition technology cannot be applied to persons who are unable to open their eyes wide by nature or due to acquired diseases. The fingerprint recognition technology cannot be applied to persons who have worn fingerprints. Further, the face recognition technology cannot be applied to persons whose faces have been changed by plastic surgery, and so on. Accordingly, combined biometrics technologies, instead of the various independent biometrics technologies, have recently been developed to overcome these defects.

The overall recognition accuracy of the combined biometrics technologies is generally higher than the independent biometrics technologies applied individually.

For example, it is assumed that recognition accuracies of biometrics technologies A and B, different from each other, are 90% and 80%, respectively. If the biometrics technologies A and B are applied to one hundred persons, the ninety persons are recognized through the biometrics technology A in the case where the biometrics technology A is applied to the hundred persons, and eight persons are additionally recognized through the biometrics technology B in the case where the biometrics technology B is applied to the rest ten persons not recognized by the biometrics technology A. Accordingly, the overall recognition accuracy is 98%.

When the overall recognition accuracy is expressed as a formula, the overall recognition accuracy in the case that independent biometrics technologies having independent recognition accuracies with a % and b % are applied to persons one by one, is represented as the following Formula.

[Formula]
a+(100−a)*b/100(%)

The overall recognition accuracy is higher than the case that the biometrics technologies A and B are independently applied.

Meanwhile, the conventional face recognition technology is utilized by taking a face image using a single camera, so the face image cannot be analyzed in three dimensions. Accordingly, the face recognition technology has limitations that the locations of pupils can be detected but the distance information of the pupils from an iris camera cannot be obtained, which are needed to capture the focused iris images.

Further, the conventional iris recognition technology has a disadvantage that the cost of the iris recognition system is increased due to the use of a high cost auto-focusing camera. Further, the conventional manually focused iris recognition camera system is inconvenient in that a user adjusts the focus and optical axis of a manual camera after aligning the pupils with a lens with the camera held by his hand.

Additionally, systems for iris recognition and face recognition are not operated as a module but are independently operated, so the systems are expensive and it is difficult to obtain a synergistic effect resulting from applying the location information of the pupils and the distance information of the pupils from a camera obtained in the process of the face recognition to iris recognition.

In a further improved system using a face recognition camera, one of iris recognition cameras recognizes the locations of the pupils in the process of the face recognition, and then carries out the iris recognition. However, since a single face recognition camera is used, distances of the pupils from the iris recognition camera cannot be obtained, and a user should position his pupils at the optical axis of the camera so that an image is photographed in the vicinity of the focal point of the camera.

### DESCRIPTION OF THE INVENTION

Accordingly, the present invention has been made keeping in mind the above problems occurring in the prior art, and an object of the present invention is to provide a system and method for iris recognition using stereoscopic face recognition, which can photograph irises of an authenticatee using a stereoscopic face image photographed by two or more cameras.

Another object of the present invention is to provide a method for individual identification using stereoscopic face recognition, which can identify an authenticatee using a stereoscopic face image photographed by two or more cameras without iris recognition of the authenticatee.

In order to accomplish the above object, the present invention provides a system for iris recognition using stereoscopic face recognition, including two or more face recognition cameras for photographing two or more face images of an authenticatee; a recognition system for receiving the face images photographed by the face recognition cameras from the face recognition cameras and creating stereoscopic face information on the basis of the face images; and one or more iris recognition cameras controlled by the recognition system to photograph irises of the authenticatee using the created stereoscopic face information.

In the above, it is preferable that the created stereoscopic face information includes information on distance between pupils of the authenticatee and the face recognition cameras.

Additionally, in the above, it is preferable that the system for iris recognition using stereoscopic face recognition further includes an iris recognition camera driving system for moving the iris recognition cameras on the basis of the distance information to automatically focus the iris recognition cameras on the irises of the authenticatee, the iris recognition cameras being mounted on the driving system. Accordingly, the iris recognition system photographs clear images of irises by automatically adjusting the focuses of iris recognition cameras in a software manner on the basis of the location and distance information of the pupils detected in the process of face recognition, instead of using a high cost camera with an auto-focusing function, and therefore the manufacturing cost of the iris recognition system can be reduced.

Additionally, in the above, it is preferable that the iris recognition cameras have lenses with 5 cm or more focal depth. When the authenticatee approaches the iris recognition system for his irises to be photographed, the location of the face can be recognized. Thereafter, if a message, for example, a voice message, which instructs the authenticatee to change the position of his face in upward or downward directions, left or right directions, or forward or backward directions, is transmitted to the authenticatee, the iris recognition system can easily photograph irises without using the iris recognition camera driving system. Cameras provided with telecentric lens systems can be employed as iris recognition cameras having lenses with 5 cm or more focal depth. Generally, in the case of telecentric lens systems, the focal depths of the lenses are approximately 10 cm to 15 cm.

Additionally, it is preferable that the iris recognition system further includes a body provided with a protective glass which is opaque for visible light and transparent to infrared light in a front thereof, and the iris recognition cameras therein, a region with which the irises of the authenticatee are aligned being represented on the protective glass; and an infrared illumination device disposed around the iris recognition cameras and installed in the body together with the iris recognition cameras. That is, if the protective glass is attached to the front face of the body of the iris recognition system, the region is represented on the protective glass for the convenience of the authenticatee, the iris recognition system automatically performs iris recognition when the pupils of the authenticatee are aligned with the dotted region.

In order to accomplish the above object, the present invention provides a method for iris recognition using stereoscopic face recognition, including the steps of: photographing two or more face images of an authenticatee using two or more face recognition cameras to stereoscopically photograph a face of the authenticatee; calculating a location of the face of the authenticatee and a distance to pupils of the authenticatee using a recognition software using the photographed face images; and photographing irises of the authenticatee using the calculated location of the face and the distance to the pupils.

In the above, it is preferable that the step of photographing irises is performed by photographing irises after iris recognition cameras are moved on a basis of the calculated distance of the pupils.

Additionally, in the above, it is preferable that the step of photographing irises includes the steps of: transmitting a message to the authenticatee so that the authenticatee can move to a certain location on a basis of the calculated distance to the pupils; and photographing irises if it is determined that the authenticatee has moved to the predetermined location.

Additionally, the method for using stereoscopic face recognition further includes the steps of: extracting boundaries of the irises and the pupils from the photographed irises of the authenticatee; and determining whether the authenticatee has taken a narcotic drug through a parameter analysis process for narcotic detection. Accordingly, by the method, it can be determined whether the authenticatee has taken a narcotic drug through iris recognition using stereoscopic face recognition.

In order to accomplish the other object, the present invention provides a method for individual identification using stereoscopic face recognition, including the steps of: photographing two or more face images of an authenticatee using two or more face recognition cameras to stereoscopically photograph a face of the authenticatee; extracting parts of a face of the authenticatee by a recognition software using the photographed face images; and determining whether stereoscopic face information created by the extracted parts of the face is the same as specific face information stored in a database.

In the above, it is preferable that the specific face information stored in the database is created by the steps of photographing face images and extracting parts of a face of the authenticatee.

Additionally, in the above, it is preferable that the specific face information stored in the database is generated by digitizing a picture of the authenticatee.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a control block diagram of a camera system for iris and face recognition in accordance with a preferred embodiment of the present invention;

FIG. 2 is a block diagram illustrating an interface between the camera system and an application system in accordance with the present invention;

FIG. 3 is a block diagram illustrating the application system integrated to the camera system in accordance with the present invention;

FIG. 4 is a schematic plan view of the inside configuration of the camera system of the present invention;

FIG. 5 is a perspective view of the inside configuration of the camera system of the present invention;

FIG. 6 is a perspective view of the external appearance of the camera system of the present invention;

FIG. 7 is a flowchart illustrating a method for narcotic drug detection in accordance with another embodiment of the present invention;

FIG. 8 is a flowchart illustrating a method for identifying persons in accordance with another embodiment of the present invention; and

FIG. 9 is a flowchart illustrating a process for storing face information in a face information database illustrated in FIG. 8.

### DESCRIPTION OF THE PREFERRED EMBODIMENTS

Reference now should be made to the drawings, in which the same reference numerals are used throughout the different drawings to designate the same or similar components.

Hereinafter, the construction and operation of a camera system for iris and face recognition according to a preferred embodiment of the present invention are described with reference to the accompanying drawings.

FIG. 1 is a control block diagram of the camera system for iris and face recognition in accordance with the preferred embodiment of the present invention. A control board 10 is connected to two iris recognition cameras 12 and 14 that photograph left and right irises of an authenticatee, respectively, two face recognition cameras 16 and 18 that photograph the face of the authenticatee from left and right sides, respectively, and a stepping motor that adjusts the focal distances of the iris recognition cameras 12 and 14. Further, the control board 10 is connected to a face illumination light source 22 that illuminates the face of the authenticatee, an iris illumination light source 24 that illuminates the left and right irises of the authenticatee, respectively, a transmission line 26 that allows the operations of the cameras 12, 14, 16 and 18 to be controlled through serial communication with an application system, and video signal cables 28 that transmit iris and face image information obtained by the cameras 12, 14, 16 and 18 to the application system. The face illumination light source 22 is preferably implemented as a halogen lamp or infrared light emitting-diodes. The face illumination light source 22 is preferably implemented as infrared light emitting-diodes.

Face video signals corresponding to the face image information outputted from the two face recognition cameras 14 and 16 are transmitted to a recognition software of the application system, and parts of a face constituting the face, that is, the eyes, the nose, the mouth and so on, are extracted through image processing in the process of face recognition. Accordingly, the locations of pupils can be detected on the basis of the general characteristics of a human face. Additionally, the distance information of the pupils, that is, distances between the pupils and the face recognition cameras 16 and 18, is detected by analyzing the difference between left and right side images of the face. Accordingly, the moving distances of the iris recognition cameras 12 and 14 are calculated, and the calculated result is transmitted to the control board 10. The iris recognition cameras 12 and 14 are moved by driving the stepping motor 20 on the basis of the calculated result, so the focuses of the iris recognition cameras 12 and 14 are fixed on the irises and the irises are photographed. In this case, an interface that allows serial communication between the control board 10 and the application system through the transmission line 26 is implemented.

Although the number of the face recognition cameras is two in the embodiment of the present invention, the more stereoscopic face information can be obtained if a front face image can be photographed in the case of employing three or more face recognition cameras, so the accuracy of overall recognition can be increased.

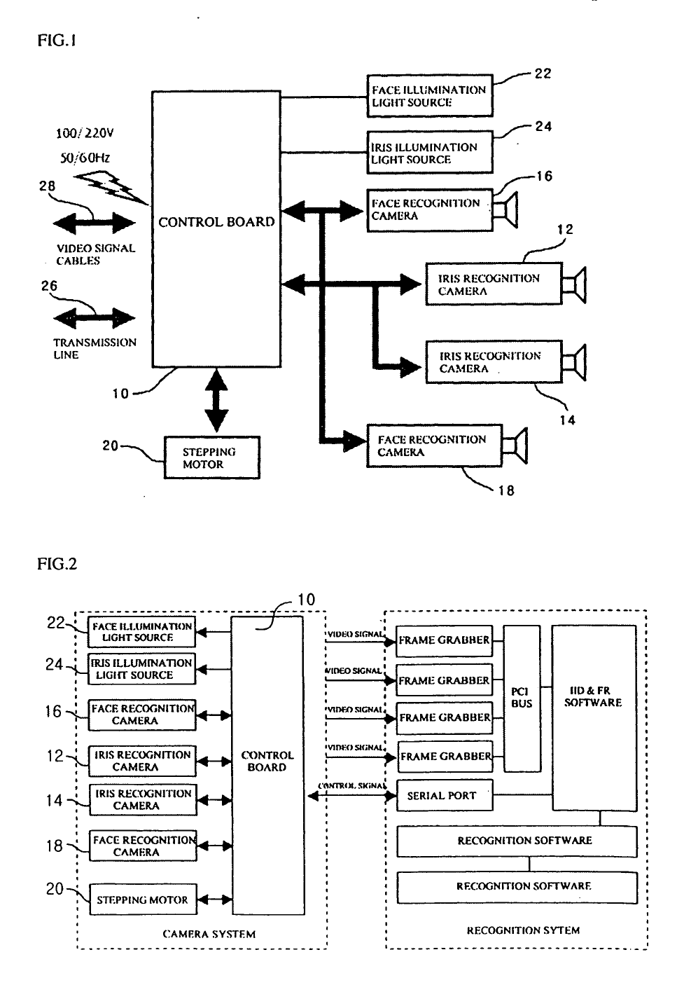

FIG. 2 is a block diagram illustrating an interface between the camera system and the application system in accordance with the present invention. The application system includes a plurality of frame grabbers, a serial port, a Peripheral Component Interconnect (PCI) bus, an Independent and Identically Distributed (IID) & False Rejection (FR) software, an application interface, and the recognition software. Video signals corresponding to the iris and face image information outputted from the iris recognition cameras 12 and 14 and the face recognition cameras 16 and 18 are transmitted to the recognition software through the frame grabbers installed in the application system, and the locations the pupils and the distances between the pupils and the face recognition cameras 16 and 18 are detected through the image processing and analysis. The detected results are transmitted to the control board 10, and the focal distances of the iris recognition cameras 12 and 14 are adjusted, so the iris recognition cameras 12 and 14 can clearly photograph the irises. In this case, the frame grabbers are apparatuses that convert analog image signals into digital signals processable in computers, and output the digital signals to another apparatus. That is, the frame grabbers are apparatuses that capture images and allow the captured images to be stored in a file form, and may be implemented as general frame grabbers in the present invention.

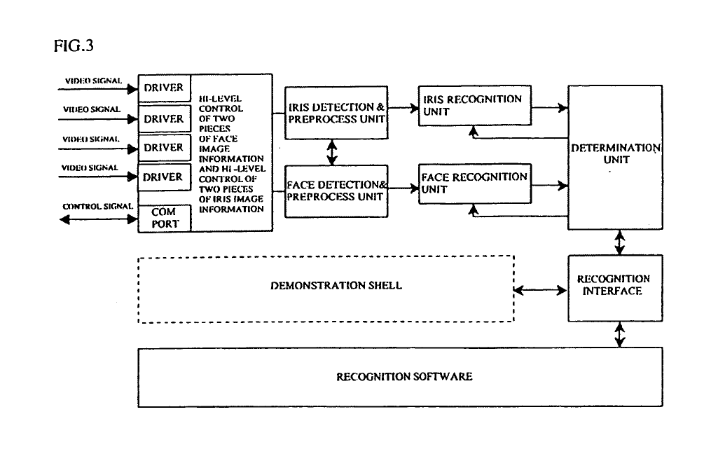

FIG. 3 is a block diagram illustrating the application system integrated to the camera system in accordance with the present invention. The application system includes a plurality of drivers, a COMmunication (COM) port, an iris detection & preprocess unit, a face detection & preprocess unit, an iris recognition unit, a face recognition unit, a determination unit, the application interface, and the recognition software. Video signals corresponding to the iris and face image information outputted from the iris recognition cameras 12 and 14 and the face recognition cameras 16 and 18 are transmitted to the recognition software installed in the application system, and an authentication result which is obtained by the iris recognition and the face recognition for an authenticatee is transmitted to the application system through the interface.

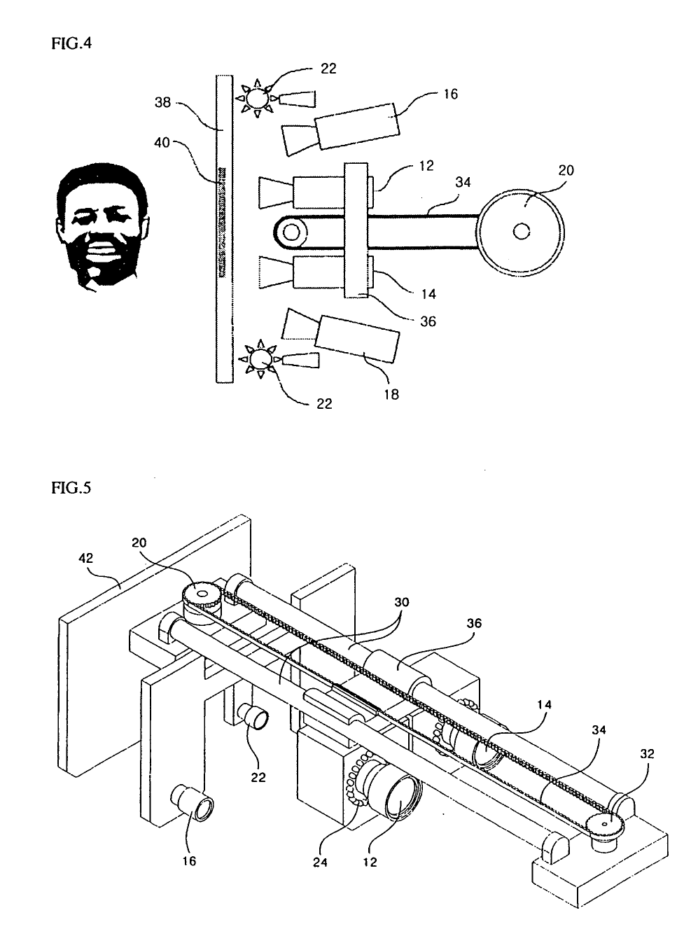

FIG. 4 is a schematic plan view of the inside configuration of the camera system of the present invention. FIG. 5 is a perspective view of the inside configuration of the camera system of the present invention, which is implemented as a single module.

The face recognition cameras 16 and 18 for photographing left and right sides of a face are disposed at lower left and right side portions of a body of the camera system. The iris recognition cameras 12 and 14 are disposed above and inside the face recognition cameras 16 and 18. The iris recognition cameras 12 and 14 are disposed so that a distance between them corresponds to the distance between the irises of a person. The iris recognition cameras 12 and 14 are fixedly attached to a supporting bracket 36, which is fitted around guide shafts 30, fixed to a toothed chain 34 wound around a stepping motor 20 and a roller 32, and moved by the stepping motor 20 to perform a focus adjusting function. Accordingly, the iris recognition cameras 12 and 14 carry out linear motion in the horizontal direction using the toothed chain 34 driven by the stepping motor 20, and move a short distance or a long distance from the irises of an authenticatee, so the focuses of the iris recognition cameras 12 and 14 are adjusted.

Although the stepping motor 20, the toothed chain 34, the roller 32, and the supporting bracket 36 constitute an iris recognition camera driving system in the preferred embodiment of the present invention, the elements of the driving system are not limited to the above elements and can be variously modified or adjusted by the person skilled in the art.

Meanwhile, when the irises of the authenticatee are not focused on the iris recognition cameras, a message is transmitted to the authenticatee so that the authenticatee can move to a predetermined location where the irises are focused, instead of directly moving the iris recognition cameras. If it is determined that the authenticatee has moved to the predetermined location, the irises are photographed. In this case, it is preferable that the focal depths of the lenses of the iris recognition cameras are more than 5 cm.

Meanwhile, the iris illumination light source 24 for illuminating the irises of the authenticatee is implemented as a plurality of the infrared light emitting diodes, which are disposed along the outer circumferences of the iris recognition cameras 12 and 14. Although an example in which the face illumination light source 22 is implemented as a halogen lamp is described in FIG. 5, it is obvious to those skilled in the art that the face illumination light source 22 may be implemented as the infrared light emitting diodes instead of the halogen lamp.

Further, a reflecting plate 42 is disposed behind the body, that is, behind the iris recognition cameras 12 and 14 and face recognition cameras 16 and 18.

The above-described camera system detects the locations of the pupils and the distances between the pupils and the face recognition cameras 16 and 18 in the process of the face recognition, drives the stepping motor 20 on the basis of the detected results, and moves the iris recognition cameras 12 and 14 disposed to the guide shafts 30 to locations in which the focuses of the iris recognition cameras 12 and 14 are clearly fixed on the irises. Thereafter, iris recognition is carried out. If the iris recognition is completed, the camera system controls the iris recognition cameras 12 and 14 to return to their original locations.

Accordingly, the camera system of the present invention implements a focus adjusting function for the irises in a software manner using the face recognition instead of using a high cost automatic focus camera.

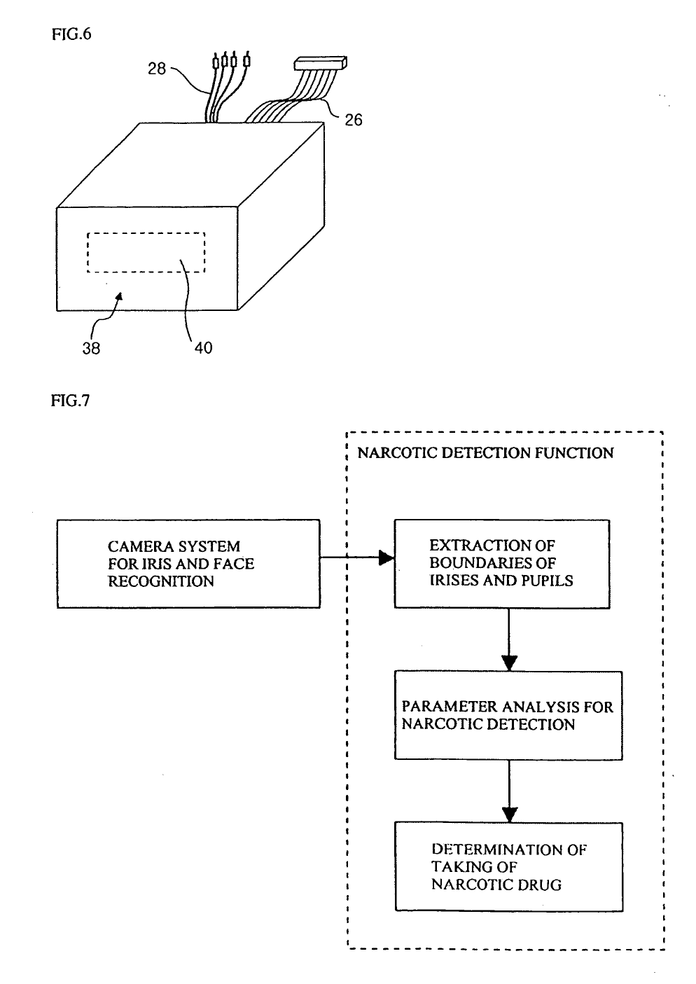

FIG. 6 is a perspective view of the external appearance of the camera system of the present invention. Referring to FIG. 6, the camera system is implemented as a single module, and the front face of the camera system is formed by a protective glass 38. A region 40 represented by a dotted line is defined around the center part of the protective glass 38, which indicates the area with which the iris recognition cameras 12 and 14 are aligned. Accordingly, if the pupils of the authenticatee are aligned with the region 40 indicated by the dotted line, the face recognition and the iris recognition are automatically carried out. The protective glass 38 is constructed as a one-way mirror so that the inside of the camera system cannot be seen from the outside of the camera system. Accordingly, the iris and face images of the authenticatee are photographed using the protective glass 38 that transmits infrared rays and does not transmit visible rays, with illumination being controlled by infrared light. The transmitting of infrared rays means that 50% or more of infrared rays are transmitted through the protective glass 38, while the not-transmitting of visible rays means that 50% or less of visible rays are transmitted through the protective glass 38.

This construction is used to increase user's convenience. That is, when the user aligns his pupils with the region 40 within the dotted line, the face recognition and the iris recognition are automatically carried out.

Hereinafter, a method of recognizing irises using the above-described camera system is described.

First, the face of the authenticatee is photographed from left and right sides using the face recognition cameras 16 and 18 so as to obtain stereoscopic face information.

Face video signals corresponding to face image information photographed by the face recognition cameras 16 and 18 are transmitted to the recognition software. Thereafter, the locations of the pupils are detected by extracting parts of the face constituting the face, that is, the eyes, the nose, the mouth and so on, through the image processing of the face recognition. Thereafter, the distances between the pupils and the face recognition cameras 16 and 18 are calculated by analyzing the difference between left and right side images of the face so as to adjust the focuses of the iris recognition cameras 12 and 14.

Thereafter, the camera system receives the distances between the pupils and the face recognition cameras 16 and 18 calculated as described above from the application system, moves the toothed chain 34 engaged with the stepping motor 20 on the basis of the distances, and adjusts the focuses of the iris recognition cameras 12 and 14 through the movement of the iris recognition cameras 12 and 14.

Thereafter, if the focus adjusting is completed, the iris recognition cameras 12 and 14 photograph the irises of the authenticatee, and output iris video signals corresponding to the photographed iris image information to the application system through the video signal cables 28, so iris recognition is carried out. If the iris recognition is completed by the application system, the camera system controls the iris recognition cameras 12 and 14 to return to their original locations by transmitting a control signal to the control board 10 through the transmission line 26, and prepares for a next photographing process.

FIG. 7 is a flowchart illustrating a method for narcotic detection in accordance with another embodiment of the present invention.

When narcotic detection is carried out, pupils are photographed by the iris recognition cameras 12 and 14 using the locations of the pupils and the distances between the pupils and the face recognition cameras 16 and 18 detected in the process of face recognition of the above-described camera system.

Thereafter, the boundaries of the irises and pupils are extracted from image information outputted from the iris recognition cameras 12 and 14, and it is finally determined whether an authenticatee has taken a narcotic drug through a parameter analysis process for the narcotic detection, as explained below.

The parameter analysis process for the narcotic detection is disclosed in Korean Pat. Unexamined Publication No. 2001-0097736 entitled “a method of detecting narcotic drugs using movement of pupils”. The analysis is performed as follows. First, the movement of pupils in response to a physical stimulus applied one or more times, for example, light, sound, and heat, is photographed. Parameters, for example, initial pupil sizes, delay time of pupil contraction, response intensity of parasympathetic nerves, average response time of parasympathetic nerves, change rate of response time of parasympathetic nerve, minimum pupil sizes, duration of response of sympathetic nerves, change of response time of sympathetic nerve, and response intensity of the sympathetic nerve, are calculated from an obtained graph of the movement of pupils photographed by the iris recognition cameras 12 and 14. Thereafter, it is determined whether a narcotic drug has been taken according to each of conditions by comparing the calculated parameters with parameters for a normal person.

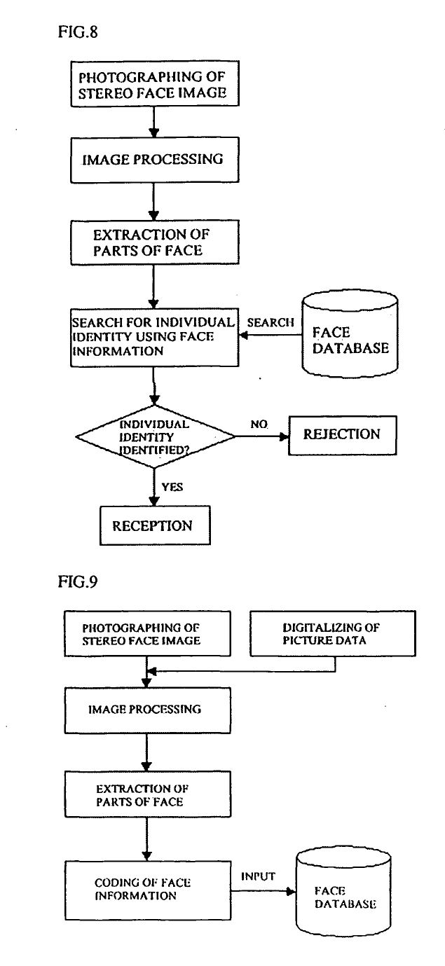

FIG. 8 is a flowchart illustrating a method for identifying persons in accordance with another embodiment of the present invention. FIG. 9 is a flowchart illustrating a process for storing face information in a face information database illustrated in FIG. 8.

The face images of an authenticatee are photographed by two or more face recognition cameras.

Thereafter, the parts (eyes, nose, mouth and so on) of the face of the authenticatee are extracted using the photographed face images through image processing in the recognition software. Thereafter, it is determined whether stereoscopic face information created by the extracted parts of the face is the same as specific face information stored in a face database. Through these processes, a person can be identified using stereoscopic face information in the case where data on his irises does not exist.

A face database for searching for individual identity stores data created by extracting the parts of a face through the image-processing of data photographed by the face recognition cameras, or data created by digitizing general pictures, such as, pictures on criminals, terrorists and so on.

Industrial Utility

As described above, the system for iris recognition according to the present invention is a multi-biometrics camera, which is implemented as a single module, thereby being easily used in conjunction with the application system and increasing recognition accuracy.

Further, the present invention provides a method for individual identification using stereoscopic face recognition, which can identify an authenticatee using a stereoscopic face image photographed by two or more cameras without needing to perform iris recognition of the authenticatee.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A system for iris recognition using stereoscopic face recognition, comprising:
two or more face recognition cameras for photographing two or more face images of an authenticatee;
a recognition system for receiving the face images photographed by the face recognition cameras from the face recognition cameras and creating stereoscopic face information on the basis of the face images; and
one or more iris recognition cameras controlled by the recognition system to photograph irises of the authenticatee using the created stereoscopic face information.

2. The system for iris recognition using stereoscopic face recognition according to claim 1, wherein the created stereoscopic face information includes information on distance between pupils of the authenticatee and the face recognition cameras.

3. The system for iris recognition using stereoscopic face recognition according to claim 2, further comprising an iris recognition camera driving system for moving the iris recognition cameras on the basis of the distance information to automatically focus the iris recognition cameras on the irises of the authenticatee, the iris recognition cameras being mounted on the driving system.

4. The system for iris recognition using stereoscopic face recognition according to claim 2, wherein the iris recognition cameras have lenses with 5 cm or more focal depth.

5. The system for iris recognition using stereoscopic face recognition according to claim 1, further comprising:
a body provided with a protective glass which is opaque for visible light and transparent to infrared light in a front thereof, and the iris recognition cameras therein, a region with which the irises of the authenticatee are aligned being represented on the protective glass; and
an infrared illumination device disposed around the iris recognition cameras and installed in the body together with the iris recognition cameras.

6. A method for iris recognition using stereoscopic face recognition, comprising the steps of:
photographing two or more face images of an authenticatee using two or more face recognition cameras to stereoscopically photograph a face of the authenticatee;
calculating a location of the face of the authenticatee and a distance to pupils of the authenticatee using a recognition software using the photographed face images; and
photographing irises of the authenticatee using the calculated location of the face and the distance to the pupils.

7. The method for iris recognition using stereoscopic face recognition according to claim 6, wherein the step of photographing irises is performed by photographing irises after iris recognition cameras are moved on a basis of the calculated distance of the pupils.

8. The method for iris recognition using stereoscopic face recognition according to claim 6, wherein the step of photographing irises comprises the steps of:
transmitting a message to the authenticatee so that the authenticatee can move to a certain location on a basis of the calculated distance to the pupils, and position of the face; and
photographing irises if it is determined that the authenticatee has moved to the predetermined location.

9. The method for iris recognition using stereoscopic face recognition according to claim 6, further comprising the steps of:
extracting boundaries of the irises and the pupils from the photographed irises of the authenticatee; and
determining whether the authenticatee has taken a narcotic drug through a parameter analysis process for narcotic detection.

10. A method for individual identification using stereoscopic face recognition, comprising the steps of:
photographing two or more face images of an authenticatee using two or more face recognition cameras to stereoscopically photograph a face of the authenticatee;
extracting parts of a face of the authenticatee by a recognition software using the photographed face images; and
determining whether stereoscopic face information created by the extracted parts of the face is the same as specific face information stored in a database.

11. The method for individual identification using stereoscopic face recognition according to claim 10, wherein the specific face information stored in the database is created by the steps of photographing face images and extracting parts of a face of the authenticatee.

12. The method for individual identification using stereoscopic face recognition according to claim 10, wherein the specific face information stored in the database is generated by digitizing a picture of the authenticatee.

13. The method for iris recognition using stereoscopic face recognition according to claim 6, wherein the step of:
calculating the tilted angle of iris images compared to the registered iris images;
and normalizing the rotation of the captured iris images to reduce the error of iris identification.
